(19) United States
(12) Patent Application Publication
(10) Pub. No.: US 2004/0210552 A1
(43) Pub. Date: Oct. 21, 2004

(54) Systems and methods for processing resource description framework data

(76) Inventors: Richard Friedman, Cherry Hill, NJ (US); Jason A. Kinner, Marlton, NJ (US); Joseph John Snyder, Shamong, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/417,373

(22) Filed: Apr. 16, 2003

(51) Int. Cl. G06F 7/00

(52) U.S. Cl. 707/1

(57) ABSTRACT

In one embodiment, a system processes resource description framework (RDF) data. The system comprises a plurality of RDF schemas defining RDF elements and relationships between ones of the RDF elements, an RDF data store for storing RDF triples that conform to the plurality of RDF schemas, and an RDF database service for receiving database transactions to add RDF triples to the RDF data store, wherein the RDF database service is operable to validate an RDF triple against the plurality of RDF schemas before populating the RDF triple into the RDF data store.

### FILED OF THE INVENTION

The present invention is related to processing resource description framework data.

### DESCRIPTION OF RELATED ART

The Resource Description Framework (RDF) is a language for representing information and resources accessible through the World Wide Web (WWW). Specifically, RDF is intended to represent metadata about Web resources, such as the title, author, and modification data of a Web page, copyright and licensing information about a Web document, the availability of some shared resource, and/or the like.

One of the advantages of RDF is its generality. Specifically, RDF provides a common framework for expressing information for exchange between applications without loss of meaning. Accordingly, RDF is not restricted to any particular type of object. For example, RDF can also be used to identify information about items that can be identified on the Web, even though these items cannot be directly retrieved on the Web.

RDF is based on the idea of identifying objects or elements using Web identifiers (URIs) and describing resources in terms of simple properties and property values. This enables RDF to represent simple statements about resources as a directed graph of nodes representing the resources, their properties, and their property values. RDF further utilizes an extensible markup language (XML)-based syntax for recording and exchanging these graphs.

Further information regarding RDF is provided in RDF Primer, W3C Working Draft 23 Jan. 2003 (available from http://www.w3.org/TR/2003/WD-rdf-primer-20030123/) which is incorporated herein by reference.

### BRIEF SUMMARY

In one embodiment, a system processes resource description framework (RDF) data. The system comprises a plurality of RDF schemas defining RDF elements and relationships between ones of the RDF elements, an RDF data store for storing RDF triples that conform to the plurality of RDF schemas, and an RDF database service for receiving database transactions to add RDF triples to the RDF data store, wherein the RDF database service is operable to validate an RDF triple against the plurality of RDF schemas before populating the RDF triple into the RDF data store.

### BRIEF DESCRIPTION OF THE DRAWINGS

FIG. 1 depicts an RDF directed graph data representation.

FIG. 2 depicts an RDF triples data representation.

FIG. 3A depicts an RDF database according to representative embodiments.

FIGS. 3B and 3C depict flowcharts of process flows that may be implemented by an RDF database according to representative embodiments.

FIG. 4 depicts an RDF repository according to representative embodiments.

FIG. 5 depicts a flowchart for processing property method transactions according to representative embodiments.

FIG. 6 depicts a metadata code set generator that performs data transcoding according to representative embodiments.

FIG. 7 depicts a computer system adapted to implement representative embodiments.

### DETAILED DESCRIPTION

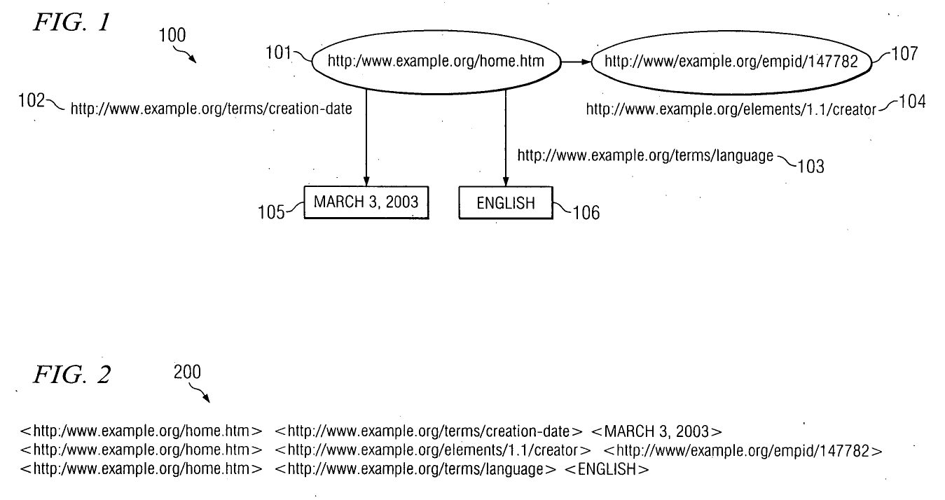

Referring now to the drawings, FIG. 1 depicts data representation 100 according to the RDF model utilized to define data relationships. The RDF model provides a methodology for describing relationships between web identifiable objects. Specifically, the RDF model defines the relationships utilizing a subject, predicates, and objects mapped onto a directed graph. In this example, the RDF model is used to describe characteristics of a web page (i.e., the creator, the creation date, and the language). Specifically, data representation 100 identifies node 101 utilizing a URI (http:/www.example.org/home.htm). Node 101 is a subject node, in these relationships, because the directed graph structure may only proceed from the subject node to the other nodes. The relationships between the nodes are defined by predicates 102, 103, 104: “http://www.example.org/terms/creation-date”, “http://www.example.org/terms/language”, and “http://www.example.org/elements/1.1/creator”, respectively. Objects 105, 106, and 107 define the value associated with the relationship. The values may be literals such as “MARCH 3, 2003” and “ENGLISH” for objects 105 and 106. Alternatively, values in the RDF model may be other identifiable web resources such as object 107 as defined by “http://www.example.org/empid/147782”.

FIG. 2 depicts data representation 200 of data representation 100 according to conventional RDF “triples” notation. Each triple includes a respective subject, predicate, and object. Each triple represents a single path in the directed graph shown in data representation 100. Data representation 200 may be implemented in a number of ways. Typically, data representation 200 may be encoded with XML representations.

Utilizing a directed graph and web identifiers to define data relationships is advantageous for a number of reasons. First, the use of web identifiers (in lieu of static literal descriptors such as “creation-date”) enables the properties used by a given entity to be differentiated from the properties used by another entity which otherwise would be identified by the same name. Moreover, by utilizing a directed graph, it is relatively straight-forward to extend the description of the subject. For example, a predefined data structure or class need not be rigidly defined to represent all possible characteristics of subject 101.

RDF does not define a manner in which such data relationships are to be stored. Several implementations exist. For example, known implementations map RDF to a relational database structure which may be queried utilizing standard query language (SQL) queries. However, relational databases can be problematic when storing RDF data. Specifically, relational databases store and process data in the database according to a table model. This model is different from the directed graph model used by RDF. The differences may produce less than optimal results when populating the database, modifying the database structure, and performing other database management activities.

Moreover, RDF does not provide any mechanism for validating stored values of objects in view of the relationships defined by the predicates. Specifically, RDF Primer, W3C Working Draft 23 Jan. 2003 states that “when a URIref does identify a datatype, RDF itself does not define the validating of the pairing of that datatype with a particular literal. This validity can only be determined by software built to understand that data type.”

The mechanism to define a vocabulary in RDF is referred to as an RDF schema. An RDF schema enables a particular entity to define types of things (e.g., creator, see predicate 104), properties (e.g., creation-date, see predicate 102), to define the types of things that can serve as subjects or objects (e.g., specifying that the value of an “age” property should be represented by an integer). RDF schema enables resources to be defined as being instances of classes (in much the same way as object-oriented programming defines classes). The classes may be structured hierarchically.

In an RDF schema, a class is defined by providing a resource having an rdf:type property whose value is the RDFS-defined resource rdfs:Class. For example, a real estate contract class could be defined using <http://www.example.org/schema/documents/contract/real_estate><rdf:type><rdfs:Class>. A particular document (e.g. identified by http://www.example.org/warrantydeed.doc) could be identified as being an instance of the real estate contract class by <http://www.example.org/warrantydeed.doc><rdf:type><http://www.example.org/schema/documents/contract/real_estate>.

Resources may also be defined as an instance of multiple classes in a similar manner. Furthermore, subclasses may be defined in a similar manner. Properties of a class may be defined by assigning the property a URI and by describing that resource using rdf:Property. To define the relationship between a property and a particular data type (e.g., a resource such as an employee), rdfs:range may be employed.

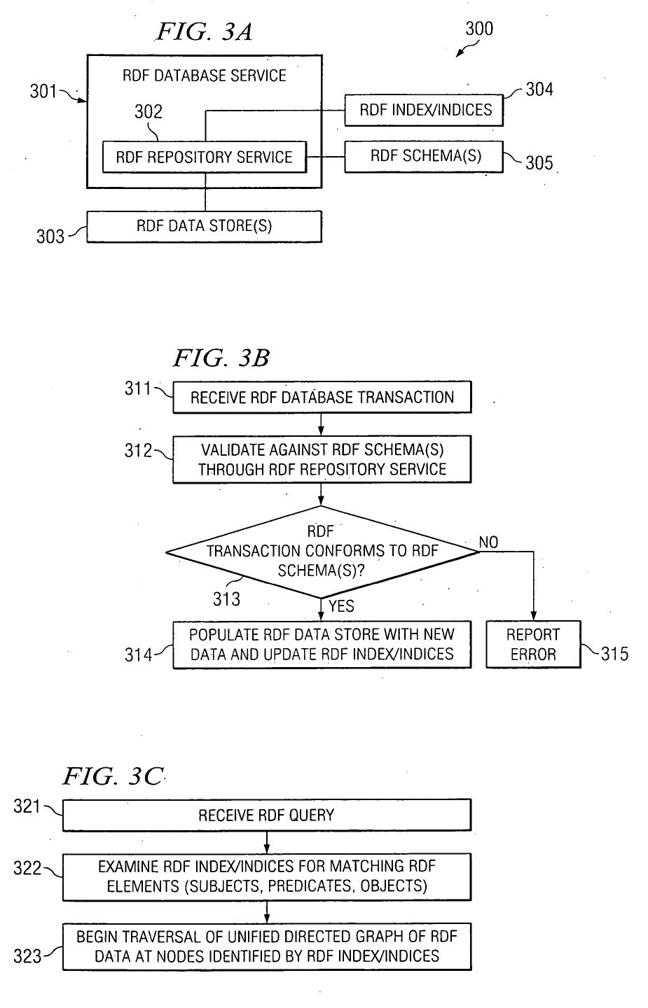

FIG. 3A depicts RDF database 300 according to representative embodiments. RDF database 300 advantageously optimizes the storage and/or processing of the data according to the RDF model. RDF database 300 differs from known database structures by utilizing the directed graph conceptualization of RDF to store and process data stored in the database. Furthermore, by utilizing the directed graph as a model, RDF database 300 enables additional schema to further constrain or open the existing model of data without requiring appreciable modification of the physical storage of the constitute native data.

RDF database 300 includes RDF database service 301 which may be implemented as a service accessible in an application server environment. RDF database service 301 may be utilized as an interface to receive RDF data for populating the database, to receive RDF database queries, and to provide results in response to RDF database queries.

RDF repository service 302 of RDF database service 301 may enforce the relationships defined by RDF schema(s) 305 for data stored in RDF data stores(s) 303. To enforce the relationships, RDF repository service 302 provides a unified view of RDF schema(s) 305. Specifically, RDF repository service 302 utilizes the directed graph model of RDF to assemble a comprehensive map of the relationships defined by RDF schema(s) 305. Thus, each relationship, applicable to each resource, class, subclass, property, and/or the like, may be determined on a dynamic basis. By creating a suitable unified view of RDF schema(s) 305, RDF repository service 302 enables flexible extension and adaptation of RDF schema(s) 305. For example, subsequent sets of schemas may be added to RDF schema(s) 305. The additional schemas may place further constraints on relationships previously defined in earlier sets of schemas. RDF repository service 302 enables these additional constraints to be dynamically enforced despite the fact that all of the constraints are successively expressed in different sets of schema.

When data is populated into the database using the RDF model, the data may be expressed in terms of an RDF statement (e.g., an RDF triple). RDF repository service 302 may examine the relationship defined by the RDF statement against constraints expressed by one or several schema of RDF schema(s) 305 via the unified view of RDF schema(s) 305. If the RDF statement is consistent with the constraints, the RDF statement may be stored in the database by storing appropriate data in RDF data store(s) 303 and, possibly, updating RDF index/indices 304. If the RDF statement is inconsistent with the constraints, an error condition may be reported thereby preserving the data integrity of RDF database 300.

In addition to maintaining the integrity of the data, RDF database 300 may further utilize the graph structure of RDF data to optimize database query processing. RDF database service 301 may organize the storage of RDF data in RDF data store(s) 303 according to a unified view of the RDF data in much the same way that RDF repository service 302 maintains a unified view of RDF schema(s) 305. By maintaining a unified view of the RDF data, an identification of a particular resource enables each statement regarding the resource to be determined by traversing the individual paths from that resource.

RDF index/indices 304 may facilitate the mapping of RDF data to native data stored in RDF data store(s). Moreover, RDF index/indices 304 may enable the directed graph structure of the RDF data to be traversed in an efficient manner. For example, RDF index/indices 304 may provide references according to particular values of objects for a defined relationship. For example, an index of all values of the object “AuthorName” related to resources by the predicate “creator” may be generated to map to the respective positions in the unified view of the RDF data. When a query is received to identified resources that have “John Smith” as a creator, RDF database service 301 may access the particular index in lieu of traversing the entire unified view of the RDF data. If “John Smith” is located with the index, RDF database service 301 may retrieved the identified resources and any suitable objects of the identified resources to be returned in response to the query. In a similar manner, RDF index/indices 304 may contain references to RDF subjects that are associated with a particular RDF predicate. The searching for RDF triples according the RDF queries may begin from nodes in the unified view of RDF data as identified by RDF index/indices 304.

FIG. 3B depicts a flowchart of a process flow that may be performed by an RDF database according to representative embodiments. In step 311, an RDF database transaction is received to, for example, add an RDF triple to the RDF database. In step 312, the RDF transaction is validated against RDF schema(s) through an RDF repository service. In step 313, a logical comparison is made to determine whether the RDF transaction conforms to the RDF schema(s). If the RDF transaction conforms to the RDF schema(s), the process flow proceeds to step 314 where the RDF data store is populated with new data and, possibly, an update to the RDF index/indices is performed. If the RDF transaction does not conform to the RDF schema(s), the process flow proceeds to step 315 where a suitable error is reported.

FIG. 3C depicts a flowchart of a process flow that may be performed by an RDF database according to representative embodiments. In step 321, an RDF query is received, In step 322, the RDF index/indices may be examined for RDF elements matching query parameters (e.g., subjects, predicates, and objects). In step 323, the traversal of the unified directed graph of RDF data provided by RDF repository service begins at nodes identified by RDF index/indices/

Moreover, RDF enables metadata schemes to be designed in which relationships between properties may be defined using the “subPropertyOf” relationship. This type of mechanism is used to indicate that one property has the meaning of another property plus some additional meaning. For example, the property “ModifiedDate” may extend the concept of the property “Date” using this type of relationship. When a query is submitted for resources that have property metadata that correspond to some value, the resources that have property metadata that correspond to the value and the resources that have subproperty metadata that correspond to the value may be returned as a collection. It may be possible to modify the metadata associated with both types of resources utilizing the same mechanism. However, this may be problematic. For example, code could be created to modify property metadata before the subproperty was created. Thus, the previously created code could inappropriately modify the resources with the subproperty metadata.

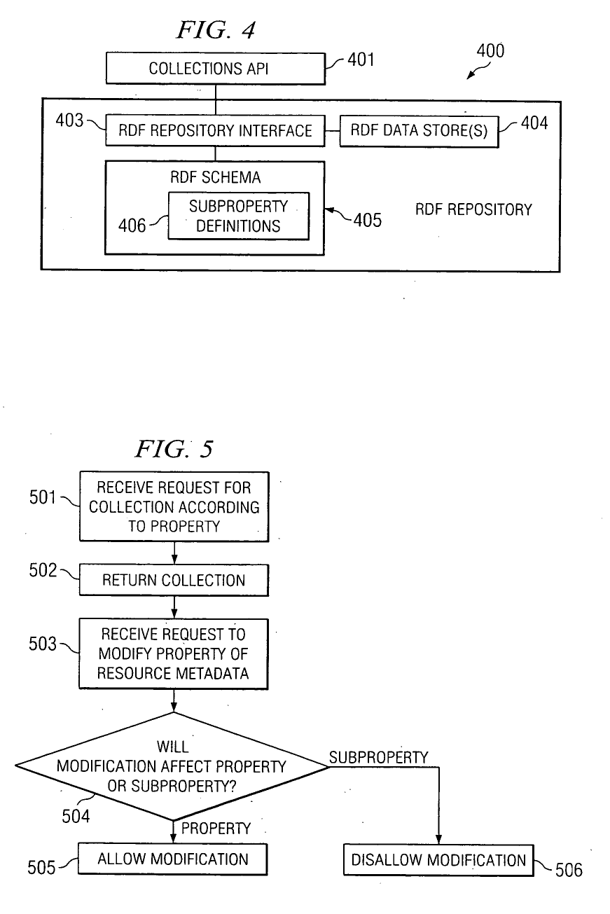

FIG. 4 depicts system 400 for processing metadata associated with properties and subproperties. Collections application programming interface (API) 401 enables software processes to obtain access to collections of resources identified according to the RDF scheme. Collections API 401 interfaces with RDF repository interface 403 of RDF repository 402. RDF repository interface 403 retrieves the appropriate resources from RDF data store(s) 404 utilizing RDF schema 405. Collections API 401 may receive requests for collections and requests to modify metadata associated with resources of the requested collections. When a request is received to modify metadata of a resource or resources of a collection, collection API 401 may utilize subproperty definitions 406 to determine whether the request is proper.

FIG. 5 depicts a flowchart for processing metadata associated with properties and subproperties according to representative embodiments. The flowchart could be implemented by system 400. Also, the flowchart could be implemented within an RDF database service if desired. In step 501, a request for a collection is received. In step 502, the collection is returned. In step 503, a request to modify a property value of resource metadata of at least one resource in the collection is received. In step 504, a logical determination is made to determine whether the requested modification will affect property metadata or subproperty metadata. If the modification will affect property metadata, the process flow proceeds to step 505 where the modification is allowed. If the modification will affect subproperty metadata, the process flow proceeds to step 506 where the modification is disallowed. By disallowing the subproperty metadata modification through the same mechanism that modifies the property metadata, data integrity may be maintained. For example, when new subproperty relationships are created, prior software applications that modify metadata associated with the property relationship(s) will not be allowed to inadvertently corrupt metadata associated with subproperty relationships.

In representative embodiments, an RDF transcoder enables metadata associated with RDF data stores to be retrieved by a variety of applications that require the respective data to be received using different data types and/or formats. For example, metadata defined according to a given schema may use an integer type while metadata defined according to a second schema may use a character string type. The metadata defined according to each schema may refer to the same physical resource. Thus, the metadata defined according to each schema may be stored using a single physical native data type. An RDF transcoder may retrieve the data from the data store in the native format and may transcode the data into the appropriate format for the respective schemas. Additionally or alternatively, RDF transcoding may perform unit conversion (e.g., from dollars to yen). The RDF transcoder may enable the transcoded data to be provided to the requesting application in the appropriate format. The RDF transcoder may be implemented as a service in a suitable application server environment.

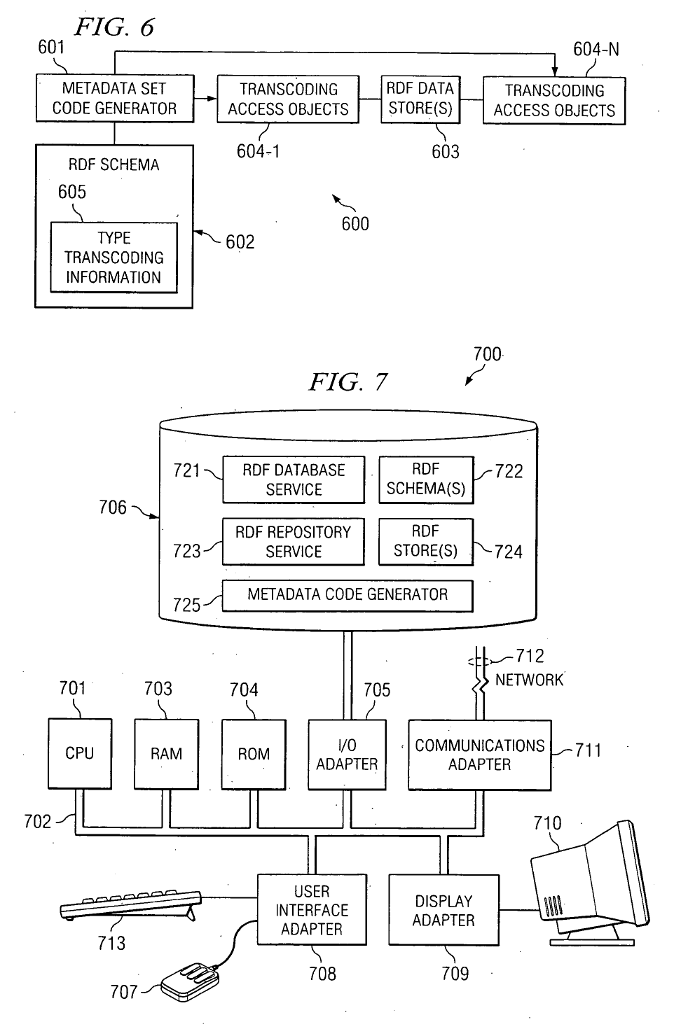

FIG. 6 depicts system 600 which implements transcoding functionality according to representative embodiments. System 600 could be incorporated within an RDF database system if desired. Alternatively, system 600 could be implemented independently of an RDF database system to be accessed directed by suitable applications. System 600 includes metadata set code generator 601. Metadata set code generator 601 is typically a software process that generates transcoding access objects 604-1 through 604-N that access RDF data store(s) 603. In representative embodiments, transcoding access objects 604-1 through 604-N enable metadata stored in association with the RDF scheme to be retrieved and/or modified. Furthermore, transcoding access objects 604-1 through 604-N may provide methods (the software code routines called to perform data retrieval and/or modification) with multiple type signatures. For example, access objects 604-1 through 604-N enable data to be returned to a calling software process using a variety of data types. A given calling software process may request the metadata to be retrieved using a string format while another calling software process may request the metadata to be retrieved using an integer format. One of access objects 604-1 through 604-N may obtain the particular metadata from RDF datastore(s) 603. The access object 604 may then transcode the data into the requested type and return the metadata to the calling software process. Access objects 604-1 through 604-N may also set the values of metadata utilizing methods that have multiple type signatures.

In representative embodiments, the transcoding functionality is automatically implemented by metadata set code generator 601. Specifically, RDF schema 602 may include type transcoding information 605 to associate relationships, classes, properties, and/or the like with multiple data types to refer to the same physical metadata stored in RDF data stores 603. Metadata set code generator 601 may analyze RDF schema 603 to identify multiple relationships defined in this manner. In response thereto, metadata set code generator 601 may create a respective transcoding access object 604 to enable access to the metadata according to the different data types of the disparate defined relationships.

When implemented via executable instructions, various elements of representative embodiments are in essence the code defining the operations of such various elements. The executable instructions or code may be obtained from a readable medium (e.g., hard drive media, optical media, EPROM, EEPROM, tape media, cartridge media, and/or the like) or communicated via a data signal from a communication medium (e.g., the Internet). In fact, readable media can include any medium that can store or transfer information.

FIG. 7 illustrates computer system 700 adapted according to representative embodiments. Central processing unit (CPU) 701 is coupled to system bus 702. CPU 701 may be any general purpose CPU. However, embodiments are not restricted by the architecture of CPU 701 as long as CPU 701 supports the operations as described herein. Computer system 700 also includes random access memory (RAM) 703, which may be SRAM, DRAM, SDRAM, or the like. Computer system 700 includes ROM 704 which may be PROM, EPROM, EEPROM, or the like. RAM 703 and ROM 704 hold user and system data and programs as is well known in the art.

Computer system 700 also includes input/output (I/O) adapter 705, communications adapter 711, user interface adapter 708, and display adapter 709. I/O adapter 705 connects to storage devices 706, such as one or more of hard drive, CD drive, floppy disk drive, tape drive, to computer system 700. Communications adapter 711 is adapted to couple computer system 700 to a network 712, which may be one or more of telephone network, local (LAN) and/or wide-area (WAN) network, Ethernet network, and/or Internet network. User interface adapter 708 couples user input devices, such as keyboard 713 and pointing device 707, to computer system 700. Display adapter 709 is driven by CPU 701 to control the display on display device 710.

Moreover, representative embodiments may store the executable code implementing the RDF processing functionality discussed above. For example, executable code defining the operations of RDF database service 721, RDF repository service 723, metadata code generator 725, and/or the like may be stored on a suitable medium accessible by one of storage devices 706. Likewise, RDF schema(s) 722 and RDF data store(s) 724 may be stored on a suitable medium accessible by one of storage devices 706.

Representative embodiments may provide a number of advantages. For example, representative embodiments may optimize the processing of RDF database transactions by adapting the structure of an RDF database. Representative embodiments may utilize database indices that correspond to the directed graph defined by RDF data. Representative embodiments may further maintain the integrity of an RDF database by enforcing RDF schema constraints as a condition of populating new data into an RDF database. Representative embodiments may further prevent data corruption from occurring by separating transactions according to property and subproperty relationships. Representative embodiments may further optimize the storage of RDF data in data stores by utilizing the same native data structures to be accessed according to multiple data type signatures defined by multiple schemas.

What is claimed is:

1. A system for processing resource description framework (RDF) data, comprising:
a plurality of RDF schemas defining RDF elements and relationships between ones of said RDF elements;
an RDF data store for storing RDF triples that conform to said plurality of RDF schemas; and
an RDF database service for receiving database transactions to add RDF triples to said RDF data store, wherein said RDF database service is operable to validate an RDF triple against said plurality of RDF schemas before populating said RDF triple into said RDF data store.

2. The system of claim 1 further comprising:
an RDF repository service that provides a unified view of a directed graph defined by said plurality of RDF schemas, wherein said RDF database service is operable to traverse said directed graph when validating an RDF triple to be added to said RDF data store.

3. The system of claim 1 further comprising:
an RDF index that contains references to RDF objects that are associated with a particular RDF predicate.

4. The system of claim 3 wherein said RDF database service receives queries for RDF elements having a relationship defined by a query predicate to an object having a query value, wherein said RDF database service is operable to traverse said RDF index to identify RDF objects that have said query value.

5. The system of claim 1 further comprising:
an RDF index that contains references to RDF subjects that are associated with a particular RDF predicate.

6. The system of claim 5 further comprising:
an RDF repository service that provides a unified view of a directed graph of said RDF triples in said RDF data store, wherein said RDF database service receives queries for RDF elements having a relationship defined by a query predicate, wherein said RDF database service utilizes said RDF index to begin traversal of said directed graph from RDF subjects associated with said query predicate.

7. The system of claim 1 wherein when said RDF database service receives a query associated with a relationship defined by a query predicate, said RDF database service provides a collection of data associated with RDF triples having said query predicate and data associated with RDF triples having a predicate that is related to said query predicate by a subproperty relationship.

8. The system of claim 7 wherein when said RDF database service receives a database transaction to modify objects of said collection related to subjects by said query predicate, said RDF database service does not modify objects having a predicate that is related to said query predicate by a subproperty relationship.

9. The system of claim 1 wherein one of said plurality of schemas defines a first RDF element according to a first data type and another of said plurality of schemas defines a second RDF element according to a second data type, each instance of said first RDF element has a corresponding instance said second RDF element, each instance of said first RDF element and its corresponding instance said second RDF element are stored as a single native data structure in said RDF data store.

10. The system of claim 9 further comprising:
a transcoder process for converting said single native data structure into at least one of said first data type and said second data type.

11. The system of claim 10 further comprising:
a transcoder generator process that examines said plurality of schemas to create said transcoder process.

12. The system of claim 10 wherein said transcoder process comprises multiple data type signatures for accessing metadata according to said first data type and for accessing an RDF element according to said second data type.

13. A method for processing resource description framework (RDF) data, comprising:
receiving an RDF database transaction to populate an RDF database with an RDF triple;
traversing a unified directed graph of a plurality of RDF schemas to determine whether said RDF triple conforms to relationships defined by said plurality of RDF schemas; and
adding said RDF triple to an RDF data store when said traversing determines that said RDF triple conforms to relationships defined by said plurality of RDF schemas.

14. The method of claim 13 further comprising:
updating an RDF index according to said added RDF triple, wherein said RDF index contains references to RDF objects that are associated with a particular RDF predicate.

15. The method of claim 14 further comprising:
receiving an RDF database query for RDF elements having a relationship defined by a query predicate to an object having a query value;
searching said RDF index to identify RDF objects corresponding to said query value; and
traversing a unified view of a directed graph defined by RDF triples in said data store according to said searching said RDF index.

16. The method of claims 13 further comprising:
updating an RDF index according to said added RDF triple, wherein said RDF index contains references to RDF subjects that are associated with a particular RDF predicate.

17. The method of claim 13 further comprising:
receiving a database query to identify RDF elements according to a query predicate;
returning a collection of RDF elements that includes RDF data associated with said query predicate and RDF data associated with a predicate that is related to said query predicate by a subproperty relationship;
receiving a database transaction to modify objects of said collection related to subjects by said query predicate; and
modifying only objects related to subjects by said query predicate and leaving objects related to a predicate related to said query predicate by a subproperty relationship unmodified.

18. The method of claim 13 wherein one of said plurality of schemas defines a first RDF element according to a first data type and another of said plurality of schemas defines a second RDF element according to a second data type, each instance of said first RDF element has a corresponding instance said second RDF element, each instance of said first RDF element and its corresponding instance said second RDF element are stored as a single native data structure in said RDF data store.

19. The method of claim 13 further comprising:
transcoding said single native data structure into at least one of said first data type and said second data type when accessing an instance of one of said first RDF element and its corresponding second RDF element.

20. The method of claim 19 wherein said transcoding is performed by a software process that is dynamically generated according to said plurality of schemas.

21. A system for processing resource description framework (RDF) data, comprising:
means for defining RDF elements and relationships between ones of said RDF elements;
means for storing RDF triples that conform to said plurality of RDF schemas; and
an RDF database means for receiving database transactions to add RDF triples to said RDF data store, wherein said RDF database means is operable to validate an RDF triple against said means for defining before populating said RDF triple into said RDF data store.

22. The system of claim 21 further comprising:
means for providing a unified view of a directed graph defined by means for defining, wherein said RDF database means is operable to traverse said directed graph when validating an RDF triple to be added to said RDF data store.

23. The system of claim 21 further comprising:
RDF index means for storing references to RDF objects that are associated with a particular RDF predicate.

24. The system of claim 23 wherein said RDF database means receives queries for RDF elements having a relationship defined by a query predicate to an object having a query value, wherein said RDF database means is operable to traverse said RDF index to identify RDF objects that have said query value.

25. The system of claim 21 wherein when said RDF database means a query associated with a relationship defined by a query predicate, said RDF database means provides a collection of data associated with RDF triples having said query predicate and data associated with RDF triples having a predicate that is related to said query predicate by a subproperty relationship.

26. The system of claim 25 wherein when said RDF database means receives a database transaction to modify objects of said collection related to subjects by said query predicate, said RDF database means does not modify objects having a predicate that is related to said query predicate by a subproperty relationship.

27. The system of claim 21 wherein said means for defining includes a plurality of schemas, one of said plurality of schemas defines a first RDF element according to a first data type and another of said plurality of schemas defines a second RDF element according to a second data type, each instance of said first RDF element has a corresponding instance said second RDF element, each instance of said first RDF element and its corresponding instance said second RDF element are stored as a single native data structure in said RDF data store.

28. The system of claim 27 further comprising:
transcoder means for converting said single native data structure into at least one of said first data type and said second data type.
